(19) United States
(12) Patent Application Publication
(10) Pub. No.: US 2017/0280806 A1
(43) Pub. Date: Oct. 5, 2017

(54) ARRANGEMENT COMPRISING ITEMS OF PERSONAL HEADGEAR CONNECTED BY BANNERS

(71) Applicant: MD WERKZEUGBAU GMBH, Hoechstadt (DE)

(72) Inventor: Juergen DRESEL, Hoechstadt (DE)

(21) Appl. No.: 15/509,127

(22) PCT Filed: Aug. 28, 2015
(86) PCT No.: PCT/DE2015/100360

§ 371 Date: Mar. 6, 2017

(30) Foreign Application Priority Data
Sep. 24, 2014 (DE) 20 2014 104 579.1

(51) Int. Cl. A42B 1/24; A41D 20/00; G09F 21/02; A42B 1/02; G09F 17/00; A42B 1/06; A41D 27/08

(52) U.S. Cl. CPC A42B 1/248; A42B 1/062; A41D 20/00; A41D 27/08; A42B 1/02; G09F 17/00; G09F 21/026; G09F 2021/023

(57) ABSTRACT

The invention relates to an arrangement that can be worn on the heads of members of a group. This arrangement comprises at least one banner (B1) with two side edges (B1a, B1b) and at least two items of headgear (K11, K12), each with at least one holding means (K11c, K12c) on an outside (K11b, K12b). The banner (B1) can be fixed on the holding means (K11c, K12c) via the side edges (B1a, B1b) in such a way that the items of headgear (K11, K12), and therefore also the members of the group wearing them, are connected to each other by the fabric (B1c) of the banner (B1).

The invention relates to an arrangement that is worn on the heads of members of a group.

Placards, flags and banners can be waved around by people in order to make information visible for other bystanders. Here, the information can serve for a wide range of purposes, for example can contain promotional content or can express the affiliation of a person to a group having specific properties or similarities. The problem encountered here is that these placards, etc. are usually secured to posts or bars and have to be held high by a person by hand in order to be able to be waved in a raised position.

Furthermore, for example in the case of major events, at which a very large number of people might come together, it has become usual for the spectators or participants to wear items of clothing which are provided with a decoration tailored especially to the event in question. For example, accordingly decorated jumpers, shirts, bandanas, scarves, and caps for example are worn at sporting events, such as a football, baseball, or basketball game, at music events, for example an open-air festival, but also at rallies and demonstrations. Individuals can thus express heir support for example for a sports team, an interest group, such as a union, or political party. However, this is associated with the disadvantage that items of clothing of this type and the decorations provided thereon can be covered, in particular when the individuals stand in numbers in a manner pushed closely against one another.

Document DE 19 30 664 U1 discloses a tensile advertising fabric consisting of at least two fabric parts. These can be provided with an inscription or with images and each have a zip half on at least one fabric edge. The individual fabric parts can be coupled along the corresponding cloth edges by closing the zip halves. A number of individual fabric parts can thus be chained together, and any individual fabric part can be easily exchanged.

An arrangement for securing a flag to a motorbike helmet is also described in US 2006/0021 117 A1. For this purpose, a profiled groove is arranged on the rear head region of the helmet shell of the motorbike helmet and follows the contour thereof. A flag has a profile rail on one edge. As a result, the flag can be inserted into the profile groove on the motorbike helmet. This enables a simple fixing and exchange of the flag on the helmet shell.

Furthermore, a flag arrangement for securing to a visor of an item of headgear, for example a baseball cap, is known from U.S. Pat. No. 5,881,391 A. This arrangement has at least one elongate rod with a flag which is secured to the visor of an item of headgear with the aid of a securing means. The rod is directed upwardly from the visor, approximately vertically. In addition, a banner can be clamped between two rods secured to the visor. A flag or a banner held in this way therefore can be seen, unhindered, above the item of headgear.

Document U.S. Pat. No. 9,010,000 B1 discloses an arrangement having at least one flagpole, to which a flag is secured. The flagpole can be held via a clip at the lower end thereof on a body panel of a vehicle, for example on a luggage compartment cover. A banner can be clamped over the vehicle between two flagpoles of this type.

The object of the invention is to specify an arrangement with which for example a joint interest easily can be made clearly visible to bystanders by a group of people.

The object is achieved with the arrangement of claim 1. Advantageous further embodiments of the invention are specified in the dependent claims.

The arrangement according to the invention can be worn on the heads of the members of a group. This arrangement comprises at least one banner with two side edges and least two items of headgear, each with at least one holding means on an outside. The banner can be fixed on the holding means via the side edges in such a way that the items of headgear are connected to each other by the fabric of the banner.

The invention provides the advantage that an affiliation of individuals can be made clearly visible to bystanders, in an on-going manner and without physical efforts on the part of the individuals involved. Here, the arrangement according to the invention can be used for groups of different size. Even just two individuals standing next to each other can be provided in accordance with the invention with items of headgear which are connected to each other by means of a banner. In addition, a large number of individuals stopping in the spatial vicinity of one another and thus forming a group can be connected to each other in this way.

Nevertheless, the freedom of movement of the individuals when selecting a suitable length of the banner disposed between two individuals is hardly limited. In practice, it is therefore quite possible that the individuals even within a larger group connected to each other by means of an arrangement according to the invention nonetheless can physically distribute themselves individually and can also change location. Individuals of a group within a large crowd of people can thus arrange themselves individually, for example can form chains, circles, stars or other geometric figures, outlines of emblems, and many more. Furthermore, in particular the surfaces of the banners or fabrics thereof can have graphic designs individually adapted to a current event or can serve as carriers for such designs.

The arrangement according to the invention can be particularly advantageously used when a large number of people are participating in a major event, for example in a sporting or music event in an arena or a stadium or in a meeting within the scope of the demonstration. Here, the members belonging for example to a small group can make their affiliation visible to bystanders with the aid of an arrangement according to the invention, for example with the aid of individual information on the banners. For example, details of a joint interest or local or regional origin, and/or details of a specific service offer, and many more can be provided. The invention offers the further advantage that the arrangement with (usually individual) group information displayed on the associated banners can readily be added to the items of clothing, such as T-shirts and jumpers, tailored to a specific event.

In a preferred further embodiment of the invention, a holding means is formed detachably on at least one item of headgear. This makes it possible for a banner to be separated from the corresponding item of headgear as soon as an excessively high tensile force occurs in the fabric of the banner.

A detachable connection of this type offers a large number of advantages. The banners thus can be easily exchanged for other banners that have altered inscriptions and designs. Furthermore, this embodiment of the invention also offers increased protection against accidents. A side edge of such a banner can thus detach automatically from an item of headgear, for example if a third person becomes caught in the banner or the members of the group wearing the items of headgear accidentally move too far away from one another. In addition, it is thus possible to reduce the risk of a banner tearing or of the item of headgear connected thereto being pulled down uncontrollably from the head of the person wearing the item of headgear. In addition, such an embodiment of the invention makes it easier for an increasing or decreasing number people to become integrated into a group of people connected by means of the arrangement according to the invention and uncoupled therefrom again, easily and quickly.

For this purpose, a holding means on at least one item of headgear can particularly advantageously have a hook-and-loop strip, to which at least one banner can be fixed at a side edge. This can be possible without further aids, particularly if the fabric cloth of the banner has a roughness to which a hook-and-loop strip can adhere. For a particularly reliable detachable connection, at least one banner can have an additional hook-and-loop counter strip on a side edge, which strip can be brought into engagement with a hook-and-loop strip on the holding means of an item of headgear. This embodiment offers the further advantage that the value of the tensile force necessary for a detachment can be predefined by a selection of the hook-and-loop strip and look-and-loop counter strip and in particular can be tailored to the type of items of headgear in question and the desired purpose.

In a further advantageous embodiment of the invention, at least one holding rod is extendable. Said rod is extendable for example by fitting of extension rods. In a particularly advantageous embodiment, the at least one holding rod can be extended telescopically. The visibility of attached banners is further improved as a result, and in particular enables a height adjustment of the strip edges in the case of individuals of different height.

Practically all types of items of headgear can be used with an arrangement according to the invention. In addition, a wide range of designs and embodiments of banners and also types of attachment to the items of headgear are possible. This will be explained hereinafter by way of example on the basis of the example of peaked caps, headbands, and cylinders. The invention and advantageous further embodiments thereof will thus be explained in greater detail with reference to exemplary embodiments shown in the following figures, in which

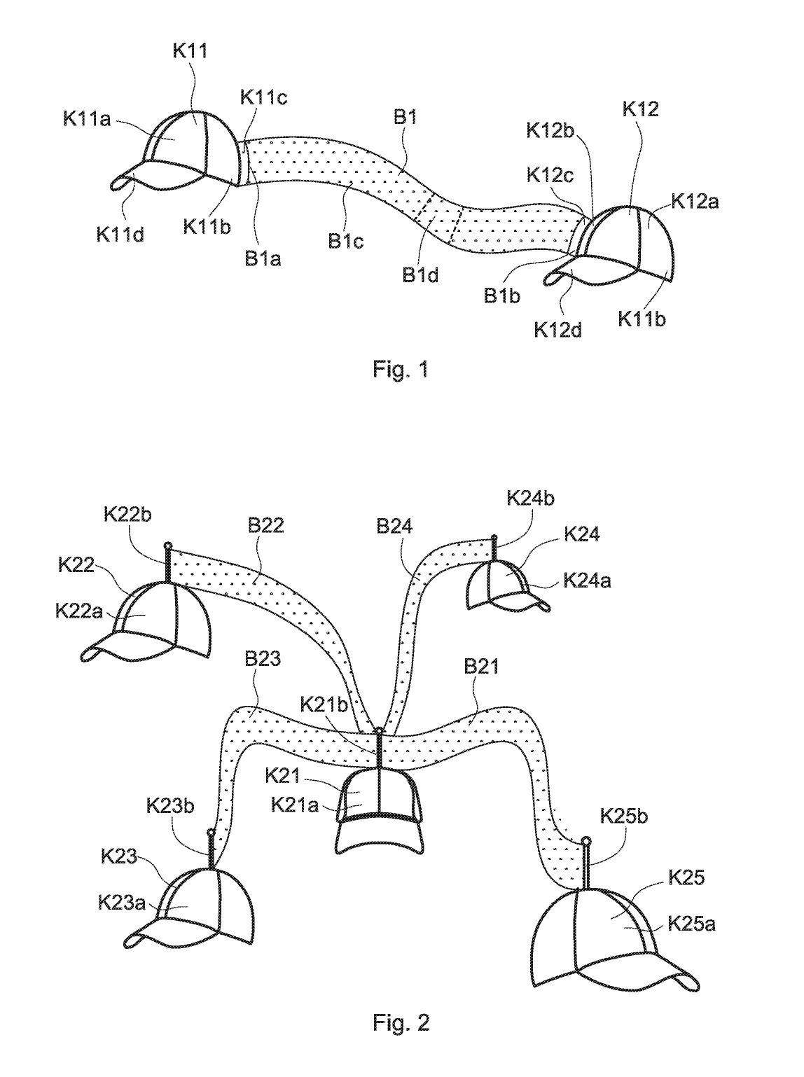

FIG. 1 shows an exemplary arrangement of two peaked caps as items of headgear, which are coupled by means of a banner in accordance with the invention,

FIG. 2 shows an exemplary arrangement of five peaked caps as items of headgear, which are coupled by means of banners in a star-shaped arrangement in accordance with the invention and have holding rods as holding means for the banners, which are each attached to the highest point of an item of headgear,

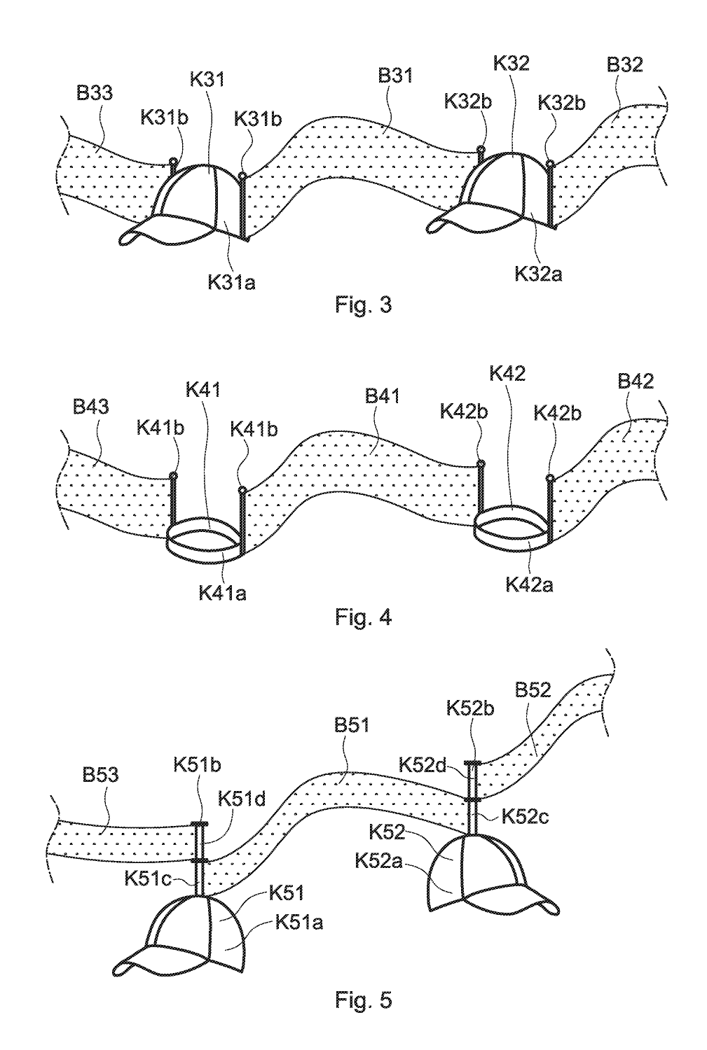

FIG. 3 shows a detail of a chain-like arrangement with, for example, two peaked caps and holding rods as holding means for the banners, which are each attached at an ear region to the outside of each item of headgear,

FIG. 4 shows a detail of a chain-like arrangement with, for example, two headbands as items of headgear and holding rods as holding means for the banners, which are each attached at an ear region to the outside of each item of headgear,

FIG. 5 shows a detail of a chain-like arrangement with, for example, two peaked caps as items of headgear and holding rods as holding means for the banners, which are each attached at the highest point of each item of headgear and have a device for automatically winding up the ends of the banners,

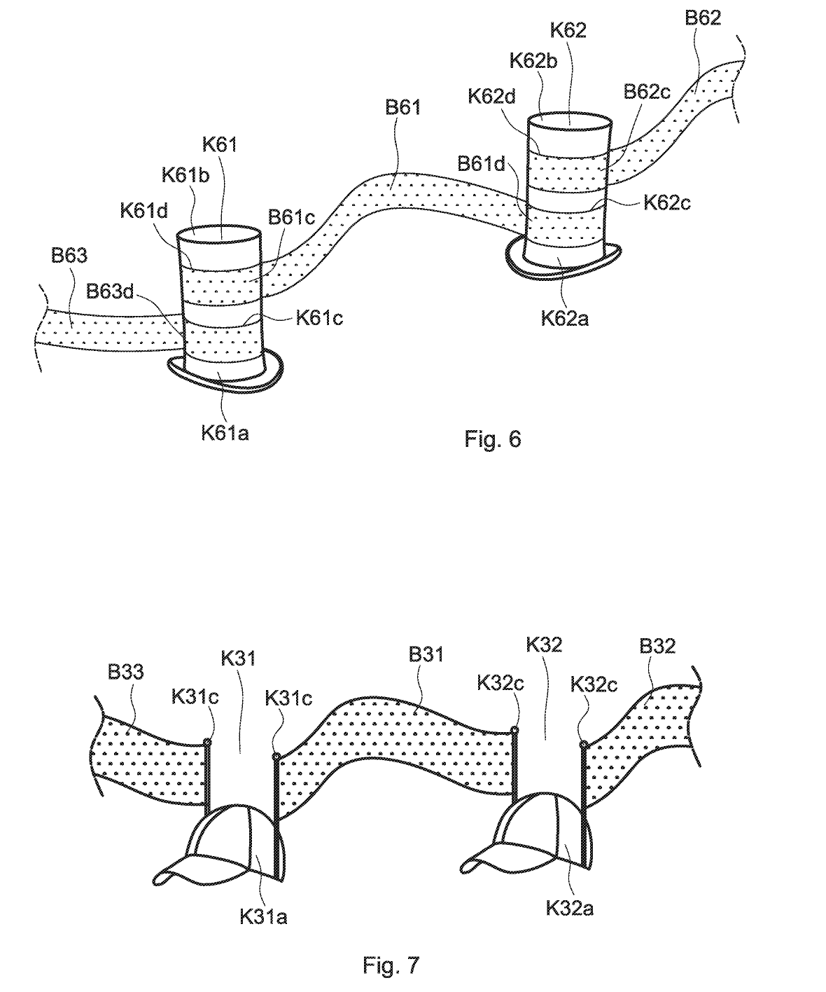

FIG. 6 shows a detail of a chain-like arrangement with, for example, two cylinders as items of headgear, wherein the cylinder lateral surfaces serve as holding means and additional winding region for the banners, and

FIG. 7 shows a detail of a chain-like arrangement with, for example, two peaked caps and holding rods as holding means for the banners, which are each attached at an ear region to the outside of each item of headgear and can be extended telescopically.

FIG. 1 shows a first exemplary arrangement according to the invention comprising a pair formed of two peaked caps K11a, K12a, for example in the form of baseball caps, with the visors K11d, K12d, as items of headgear K11, K12. These can be worn by two different people. The peaked caps K11a, K12a are coupled in accordance with the invention by means of a banner B1, which preferably is stretched in a strip-like manner. Here, the individual application-specific surface design of the banner fabric B1c is symbolised in FIG. 1 by a dotted hatching.

In the example shown in FIG. 1 the holding means K11c, K12c for attaching the banner B1 are each disposed on an outside K11b, K12b of the respective items of headgear K11, K12, for example at an ear region. The banner B1 is either permanently or detachably fixed thereto by means of the side edges B1a, B1b of the banner, for example by means of hook-and-loop strips. The banner B1 in this case advantageously has at least one resilient, stretchy region B1d. In another embodiment the fabric of the banner B1 can also be resilient over the entire extent thereof. The risk of a peaked cap being pulled down from the head of a person wearing it is hereby reduced in the event that either a third person accidentally becomes caught in the banner, or should the individuals wearing the items of headgear move too far away from one another.

FIG. 2 shows an exemplary arrangement of five peaked caps K21a, K22a, K23a, K24a, K25a as items of headgear K21, K22; K23, K24, K25, which in accordance with the invention are coupled by means of banners B21, B22, B23, B24 to form a star-shaped arrangement. The individual wearing the peaked caps K21a thus assumes a central point and is surrounded by the four individuals wearing the peaked caps K22a, K23a, K24a, K25a as items of headgear. The arrangement according to the invention nevertheless generally offers a sufficient local mobility for the five people. Should the banners be correspondingly long and additionally consist of a stretchy material as appropriate, this movability of the individuals involved is further promoted.

In the example illustrated in FIG. 2, holding rods preferably serve as holding means K21b, K22b, K23b, K24b, K25b for the banners B21, B22, B23, B24. These holding rods are each attached at the highest point to the outside of each item of headgear K21, K22, K23, K24, K25. In this way, the banners B21, B22, B23, B24 are durably placed so as to be clearly visible and as high as possible without any efforts on the part of the individuals involved. Here, the side edges of the banners can be embodied advantageously so that they can be pushed onto a holding rod. This can be embodied in a simple manner, for example by turning over the side edges and sewing them to the banner fabric in such a way that channel-like pockets are formed at both ends.

The holding rods K21b, K22b, K23b, K24b, K25b can be bent in a spring-elastic manner. On the one hand, the risk of injury is reduced as a result. Furthermore, a bendable embodiment makes it possible that one or both pocket-like side edges can be more easily removed from a bent-over holding rod on an item of headgear in the event that an inadmissibly high tensile force occurs in a banner. Since in such a case neither the holding rod nor the banner normally are damaged, the arrangement according to the invention can be produced again by once more fitting the end of the banner onto the associated holding rod. Spring-elastically bendable holding rods can consist here for example of a plastic, of rubber, or a bendable metal coil spring.

FIG. 3 shows a detail of a chain-like arrangement again with two exemplary peaked caps K31a, K32a as items of headgear K31, K32. Again, holding rods serve as holding means K31b, K32b for the banners B31, B32, B33, onto which rods the side edges at the ends can be fitted. In the example of FIG. 3, the holding rods K31b, K32b are each attached at an ear region to the outside of each peaked cap K31a, K32a.

FIG. 4 shows a detail of a further chain-like arrangement comparable to the arrangement of FIG. 5. By way of example, two headbands K41a, K42a are used as items of headgear K41, K42. Holding rods which are each attached at an ear region to the outside of each headband K41a, K42a serve as holding means K41b, K42b for the banners B41, B42, B43.

FIG. 5 shows a detail of a further chain-like arrangement with, for example, two peaked caps K51a, K52a as items of headgear K51, K52. Again, holding rods serve as holding means K51b, K52b for the banners B51, B52, B53. These holding rods are each attached at the highest point to the outside of each item of headgear K51, K52. In accordance with an advantageous further embodiment of the invention, each of the two holding rods K51b and K52b in the example of FIG. 5 is equipped with two winding devices K51c, K51d and K52c, K52d respectively, arranged one above the other. These enable an automatic winding of the ends of the banners B51, B53 and B51, B52 as soon as the tensile force in the respective banner fabrics reduces, for example due to the individuals wearing the items of headgear K51, K52 moving closer towards one another.

FIG. 6 shows a detail of a chain-like arrangement with, for example, two cylinders K61a, K62a as items of headgear K61, K62. Here, the cylinder lateral surfaces K61b, K62b on the outsides of the cylinders K61a, K62a serve as holding means for the banners B61, B62, B63. A first winding region K61c for the second side edge B63d of the banners B63 and, thereabove, a second winding region K61d for the first side edge B61c of the banner B61 are thus formed on the cylinder lateral surface K61b of the cylinder K61a. A first winding region K62c for the second side edge B61d of the banner B61 and, thereabove, a second winding region K62d for the first side edge B62c of the banner B62 are formed accordingly on the cylinder lateral surface K62b of the cylinder K62a. By winding the ends around the respective cylinder lateral surfaces, the length of the associated banner can be easily adjusted.

FIG. 7 shows a detail of a chain-like arrangement with two exemplary peaked caps K31a, K32a as items of headgear K31, K32, which for example are comparable to the embodiment from FIG. 3. Holding rods serve as holding means K31c, K32c for the banners B31, B32, B33 and can be fitted onto the side edges and can be extended telescopically. In the example of FIG. 7 the holding rods K31c, K32c are each attached at an ear region to the outside of each peaked cap K31a, K32a and are illustrated in the extended positions.

### LIST OF REFERENCE SIGNS

K11, K12 items of headgear
K11a, K12a peaked caps
K11b, K12b outsides, for example at an ear region
K11cl , K12c holding means, for example lugs with hook-and-loop strips
K11d, K12d visor
B1 banner
B1a, B1b side edges
B1c banner fabric, in particular strip-shaped
B1d resilient, stretchy region
K21, K22; K23, K24, K25 items of headgear
K21a, K22a, K23a, K24a, K25a peaked caps
K21b, K22b, K23b, K24b, K25b holding means, for example bendable holding rods
B21, B22, B23, B24 banners
K31, K32 items of headgear
K31a, K32a peaked caps
K31b, K32b holding means, for example bendable holding rods
K31c, K32c holding means, for example telescopic rods
B31, B32, B33 banners
K41, K42 items of headgear
K41a, K42a headbands
K41b, K42b holding means, for example bendable holding rods
B41, B42, B43 banners
K51, K52 items of headgear
K51a, K52a peaked caps
K51b, K52b holding means, for example bendable holding rods
K51c, K51d first, second winding device
K52c, K52d first, second winding device
B51, B52, B53 banners
K61, K62 items of headgear
K61a, K62a cylinder
K61b, K62b cylinder lateral surface as outside
K61c, K61d first, second winding region for side edge
K62c, K62d first, second winding region for side edge
B61, B62, B63 banners
B61c, B61d first, second side edge
B62c first side edge
B63d second side edge

1. An arrangement which is worn on the heads of members of a group, said arrangement comprising
a) at least one banner (B1) with two side edges (B1a, B1b), and
b) at least two items of headgear (K11, K12) each with at least one holding means (K11c, K12c) on an outside (K11b, K12b), to which the banner (B1) can be fixed via the side edges (B1a, B1b) in such a way that the items of headgear (K11, K12) worn by the individuals are connected to each other by the fabric (B1c) of the banner (B1).

2. The arrangement according to claim 1, wherein a holding means (K11c, K12c) is detachable in the event of an excessive tensile force in the fabric (B1c) of the banner (B1), such that the banner (B1) is separated from the item of headgear (K11, K12) in question.

3. The arrangement according to claim 1, wherein a holding means (K11c, K12c) has a hook-and-loop strip, to which at least one banner (B1) is fixed at a side edge (B1a, B1b).

4. The arrangement according to claim 3, wherein a banner (B1) has, on one side edge (B1a, B1b), a hook-and-loop counter strip, which engages in the hook-and-loop strip at a holding means.

5. The arrangement according to claim 1, wherein a holding means has a holding rod (K21b, K22b, K23b, K24b, K25b) on an outside of an item of headgear (K21, K22, K23, K24, K25).

6. The arrangement according to claim 5, wherein a holding rod is detachably attached to the outside of an item of headgear.

7. The arrangement according to claim 5, wherein a holding rod is attached approximately at the highest point to the outside of an item of headgear (K21, K22, K23, K24, K25).

8. The arrangement according to claim 5, wherein a holding rod (K31b, K32b) is attached approximately at an ear region to the outside of an item of headgear (K31, K32).

9. The arrangement according to claim 5, wherein a side edge of a banner is embodied such that it can be fitted onto a holding rod.

10. The arrangement according to claim 5, wherein a holding rod consists of a spring-elastically bendable material.

11. The arrangement according to claim 5, wherein a holding rod (K51b, K52b) has winding means (K51c, K51d; K52c, K52d), with which the side edge of a banner (B51, B52, B53) is rolled in automatically in the event of a decrease of the tensile force in the fabric of the banner (B51, B52, B53).

12. The arrangement according to claim 5, wherein at least one holding rod (K31c, K32c) is extendable.

13. The arrangement according to claim 12, wherein at least one holding rod (K31c, K32c) is a telescopic rod.

14. The arrangement according to claim 1, wherein the fabric (B1c) of a banner (B1) has at least one resiliently stretchable region (B1d).

15. The arrangement according to claim 1, wherein an item of headgear (K11, K12; K21 . . . 25; K31, K32; K51, K52) has the form of a peaked cap (K11a, K12a; K21a . . . K25a; K31a, K32a; K51a, K52a).

16. The arrangement according to claim 1, wherein an item of headgear (K41, K42) has the form of a headband (K41a, K42a).

17. The arrangement according to claim 1, wherein an item of headgear (K61, K62) has the form of a cylinder (K61a; K61b).

18. The arrangement according to claim 17, wherein a cylinder (K61a; K61b) has a lateral surface (K61b, K62b) with at least one winding region (K61c, K61d; K62c, K62d), around which the side edge of at least one banner (B61, B62, B63) is guided.
